(19) United States
(12) Patent Application Publication
(10) Pub. No.: US 2026/0182639 A1
(43) Pub. Date: Jul. 2, 2026

(54) HEATER ASSEMBLY AND METHOD

(71) Applicant: Nicoventures Trading Limited, London (GB)

(72) Inventors: Howard ROTHWELL, London (GB); Ugurhan YILMAZ, London (GB)

(21) Appl. No.: 19/130,369

(22) PCT Filed: Nov. 14, 2023
(86) PCT No.: PCT/GB2023/052978

§ 371 Date: May 15, 2025

(30) Foreign Application Priority Data
Nov. 15, 2022 (GB) 2217023.7

(51) Int. Cl. A24F 40/46; A24F 40/10; A24F 40/70

(52) U.S. Cl. CPC A24F 40/46; A24F 40/70; A24F 40/10

(57) ABSTRACT

Described is a heater assembly for an aerosol provision system, the heater assembly including: a substrate; a heater layer configured to generate heat when supplied with energy, the heater layer provided on a first surface of the substrate; and a plurality of capillary tubes extending from another surface of the substrate through the heater layer provided at the first surface of the substrate. Each of the capillary tubes extends to respective openings provided in the heater layer, and the combined area of the openings per unit area of the heater layer in a first region of the heater layer is greater than the combined area of the openings per unit area of the heater layer in a second region of the heater layer. Also described is an aerosol provision system comprising a heater assembly and a method for manufacturing a heater assembly.

### CROSS-REFERENCE TO RELATED APPLICATIONS

This present application is a National Phase entry of PCT Application No. PCT/GB2023/052978, filed Nov. 14, 2023, which claims priority from Great Britian Application No. 2217023.7, filed Nov. 15, 2022, each of which are fully incorporated herein by reference in their entireties.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporisation. An aerosol source for an aerosol provision system may thus comprise a heater having a heating element arranged to receive source liquid from the reservoir, for example through wicking/capillary action. While a user inhales on the device, electrical power is supplied to the heating element to vaporise source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such electronic aerosol provision systems are provided with heater assemblies suitable for heating the source liquid to form an aerosol. An example of such a heater assembly is a wick and coil heater assembly, which is formed of a coil of wire (typically nichrome NiCr 8020) wrapped or coiled around a wick (which typically comprises a bundle of collected fibres, such as cotton fibres, extending along the longitudinal axis of the coil of wire). Ends of the wick extend either side of the coil of wire and are inserted into the reservoir of source liquid. However, such heater assemblies are not necessarily suited for all applications or all configurations of electronic aerosol provision systems.

So-called microfluidic heater assemblies have been proposed to try to address some of the issues of the abovementioned heater assemblies. However, some microfluidic heater assemblies may not provide consistent aerosol delivery to a user.

Various approaches are described which seek to help address some of these issues.

### SUMMARY

According to a first aspect of certain embodiments there is provided a heater assembly for an aerosol provision system, the heater assembly including: a substrate; a heater layer configured to generate heat when supplied with energy, the heater layer provided on a first surface of the substrate; and a plurality of capillary tubes extending from another surface of the substrate through the heater layer provided at the first surface of the substrate, wherein each of the capillary tubes extends to respective openings provided in the heater layer, and wherein the combined area of the openings per unit area of the heater layer in a first region of the heater layer is greater than the combined area of the openings per unit area of the heater layer in a second region of the heater layer.

According to a second aspect of certain embodiments there is provided an aerosol provision system comprising the heater assembly of the first aspect.

According to a third aspect of certain embodiments there is provided a method for manufacturing a heater assembly for an aerosol provision system, the method including: providing a substrate; providing a heater layer on a first surface of the substrate, the heater layer configured to generate heat when supplied with energy; and providing a plurality of capillary tubes extending from another surface of the substrate through the heater layer provided at the first surface of the substrate, wherein each of the capillary tubes extends to respective openings provided in the heater layer, and wherein the combined area of the openings per unit area of the heater layer in a first region of the heater layer is greater than the combined area of the openings per unit area of the heater layer in a second region of the heater layer.

According to a fourth aspect of certain embodiments there is provided heater means for an aerosol provision system, the heater means including: a substrate; heater layer means configured to generate heat when supplied with energy, the heater layer means provided on a first surface of the substrate; and a plurality of capillary means extending from another surface of the substrate through the heater layer means provided at the first surface of the substrate, wherein each of the capillary means extends to respective openings provided in the heater layer means, and wherein the combined area of the openings per unit area of the heater layer means in a first region of the heater layer means is greater than the combined area of the openings per unit area of the heater layer means in a second region of the heater layer means.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is an exploded perspective view of a cartomiser suitable for use in the aerosol provision system of FIG. 1;

FIG. 3 is a perspective view of a heater assembly in accordance with aspects of the present disclosure, wherein the heater assembly comprises a substrate having a porous region, an electrically resistive layer, and capillary tubes extending through the substrate and electrically resistive layer;

FIG. 4 is schematic representation of capillary tubes in first and second regions of the electrically resistive layer of the heater assembly according to a first example, whereby the number of capillary tubes in a first region is greater than the number of capillary tubes in a second region;

FIG. 5 is schematic representation of capillary tubes in first and second regions of the electrically resistive layer of the heater assembly according to a second example, whereby the first region is provided with a plurality of additional smaller diameter capillary tubes such that the number of capillary tubes in a first region is greater than the number of capillary tubes in a second region;

FIG. 6 is schematic representation of capillary tubes in first and second regions of the electrically resistive layer of the heater assembly according to a third example, whereby the size (diameter or open area) of the opening of the capillary tubes in a first region is greater than the size of the opening of the capillary tubes in a second region; and

FIG. 7 is a method in accordance with aspects of the present disclosure for forming a heater assembly.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapour) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the or each aerosol-generating material may comprise one or more active constituents, one or more flavours, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or is derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

In accordance with the present disclosure, a heater assembly is provided which includes a plurality of capillary tubes extending from a first surface of substrate through a heater layer provided at a second (opposite) surface of the substrate. The plurality of capillary tubes is provided to supply liquid aerosol-generating material from the first surface of the substrate to the heater layer on the second surface of the substrate for vaporisation. In particular, the combined area of the openings of the capillary tubes per unit area of the heater layer in a first region of the heater layer is greater than the combined area of the openings of the capillary tubes per unit area of the heater layer in a second region of the heater layer. A region on the heater layer that has a relatively larger combined area of the openings of the capillary tubes provides the benefit of providing a relatively greater volume/mass of liquid to that region of the heater layer. The liquid aerosol-generating material is used as a heat-sink to help cool regions of the heater layer that would otherwise experience relatively higher temperatures. Additionally, more consistent and/or volume of aerosol may be generated accordingly from the greater volume of liquid aerosol-generating material provided.

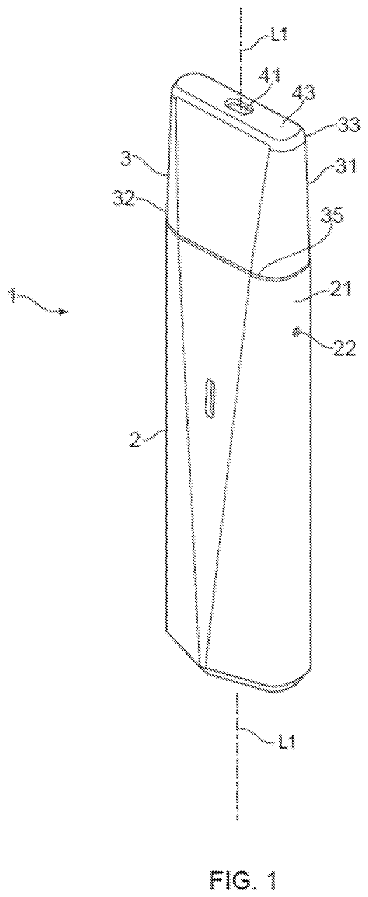

FIG. 1 schematically shows an aerosol provision system 1 in accordance with aspects of the present disclosure. The aerosol provision system 1 comprises an aerosol provision device 2 and a consumable 3, herein shown and referred to as a cartomiser 3. The aerosol provision device 2 and the cartomiser 3 together form the aerosol provision system 1.

The cartomiser 3 is configured to engage and disengage with the aerosol provision device 2. That is, the cartomiser 3 is releasably connected/connectable to the aerosol provision device 2. More specifically, the cartomiser 3 is configured to engage/disengage with the aerosol provision device 2 along the longitudinal axis L1. The cartomiser 3 and aerosol provision device 2 are provided with suitable interfaces to allow the cartomiser 3 and aerosol provision device 2 to engage/disengage from one another, e.g., a push fit interface, a screwthread interface, etc.

The cartomiser 3 comprises a reservoir which stores an aerosol-generating material. Accordingly, the reservoir may also be referred to as an aerosol-generating material storage portion. In the following, the aerosol-generating material is a liquid aerosol-generating material. The liquid aerosol-generating material (herein sometimes referred to simply as liquid, source liquid or e-liquid) may be a conventional e-liquid which may or may not contain nicotine. However, it should be appreciated that other liquids and/or aerosol-generating materials may be used in accordance with the principles of the present disclosure. The cartomiser 3 is able to be removed from the aerosol provision device 2 when, for example, the cartomiser 3 requires refilling with liquid or replacement with another (full) cartomiser 3.

The aerosol provision device 2 comprises a power source (such as a rechargeable battery) and control electronics. As will be described below, the cartomiser 3 comprises an electrically powered heater assembly. When the cartomiser 3 is coupled to the aerosol provision device 2, the control electronics of the aerosol provision device 2 are configured to supply electrical power to the heater assembly of the cartomiser 3 to cause the heater assembly to generate an aerosol from the liquid aerosol-generating material supplied thereto. The control electronics may be provided with various components to facilitate/control the supply of power to the cartomiser 3. For example, the control electronics may be provided with an airflow sensor (not shown) configured to detect when a user of the aerosol provision system 1 inhales on the aerosol provision system and to supply power in response to such a detection and/or a push button (not shown) which is pressed by the user and to supply power in response to such a detection. Additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

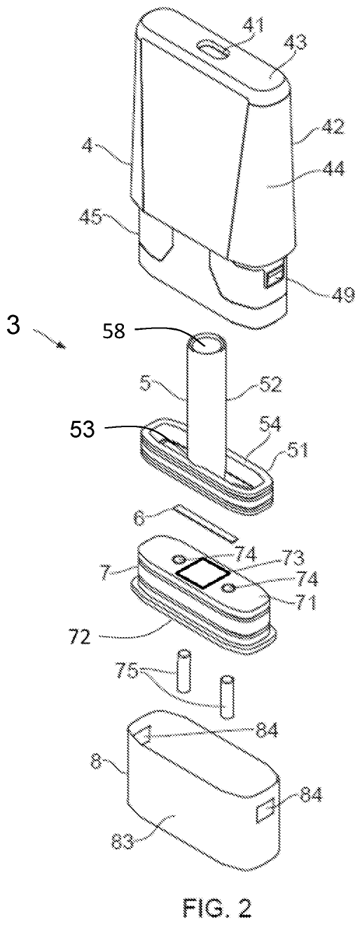

FIG. 2 shows an example cartomiser 3 suitable for use in the aerosol provision system of FIG. 1. From the exploded view of FIG. 2, it may be seen that the cartomiser 3 is assembled from a stack of components: an outer housing 4, an upper clamping unit 5, a heater assembly 6, a lower support unit 7 and an end cap 8.

The cartomiser 3 has a top end 31 and a bottom end 32 which are spaced apart along the longitudinal axis L1, which is the longitudinal axis of the cartomiser as well as being the longitudinal axis of the aerosol provision system 1. The top end 31 of the cartomiser 3 defines a mouthpiece 33 of the aerosol provision system 1 (around which a user may place their mouth and inhale). The mouthpiece 33 includes a mouthpiece orifice 41 which is provided at the top end 42 of outer housing 4 in the centre of a top face 43.

The outer housing 4 includes a circumferential side wall 44 which leads down from the top end 42 to a bottom end 45 of the outer housing 4 and which defines an internal reservoir 46 for holding the liquid aerosol-generating material. Prior to assembly of the cartomiser 3, the bottom end 45 of the outer housing is open, but upon assembly the bottom end 45 is closed by a plug formed by the upper clamping unit 5 and the lower support unit 7 which are stacked together with the heater assembly 6 sandwiched therebetween.

The upper clamping unit 5 is an intermediate component of the stack of components. The upper clamping unit 5 includes a foot 51 in the form of a block and an upwardly extending air tube 52. On each side of the air tube 52, the foot 51 includes a well 53 which descends from a flat top surface 54 to a flat bottom surface (not shown in FIG. 2) of the foot 51. At the bottom surface, each well 53 is open and, specifically, opens into an elongate recess formed in the bottom surface, with the depth of the recess broadly matching the size/shape and thickness of the heater assembly 6. The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The air tube 52 extends up from the bottom of the wells 53 and defines an internal air passage 58. When the upper clamping unit 5 is engaged with the outer housing 4, the air tube 52 extends up to and encircles the mouthpiece orifice 41. The outer housing 4 and/or the air tube 52 may be suitably configured so as to provide a liquid-(and optionally air-) tight seal between the two. As will be understood below, air/aerosol is intended to pass along the air tube 52 and out of the mouthpiece orifice 41, while the space around the air tube 52 and within the outer housing 4 defines the reservoir 46 for storing the liquid aerosol-generating material. Hence, it should be understood that, with the exception of the openings of the wells 53, the reservoir 46 is a sealed volume defined by the outer housing 4, the outer surface of the air tube 52, and the foot 51.

The lower support unit 7 is in the form of a block having a broadly flat top surface 71 and a flat bottom surface 72. A central air passage 73 extends upwardly from the bottom surface 72 to the top surface 71. On each side of the air passage 73, the block of the lower support unit 7 includes a through hole 74. In the example cartomiser 3 of FIG. 2, a co-moulded contact pad 75 in the form of a pin is inserted into the through holes 74. More specifically, each contact pad 75 is a press fit in its respective through hole 74. Each contact pad 75 provides an electrical connection path from the bottom surface 72 to a respective end portion of the heater assembly 6 when the heater assembly 6 is sandwiched between the top surface 71 of the lower support unit 7 and the recess of the bottom surface 55 of the upper clamping unit 5.

Much like the upper clamping unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper clamping unit 5 and the lower support unit 7 (with its block-like form) combine together to form a plug which seals the bottom end of the reservoir 46.

As shown in FIG. 2, the cartomiser 3 includes an end cap 8 at its bottom end. The end cap 8 is made of metal and serves to assist with retaining the cartomiser 3 in the aerosol provision device 2 when the cartomiser 3 is plugged in to the top end of the aerosol provision device 2, because, in this example, the aerosol provision device 2 is provided with magnets which are attracted to the metal of the end cap 8. The end cap 8 has a bottom wall 81 with a central opening (not shown in FIG. 2). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper clamping unit 5 and the heater assembly 6 which is sandwiched between the lower support unit 7 and the upper clamping unit 5.

It would be possible to omit the end cap 8 (in order to reduce the component count) by arranging for the lower support unit 7 to form a snap-fit type connection with the bottom end of the side wall 44 of the outer housing 4. Additionally, the cartomiser 3 could be provided with indentations which engage with projections at the top end 21 of the main housing 2, so that a releasable connection is provided between the cartomiser and the main housing.

In any case, the cartomiser 3 is provided what may more generally be referred to as a device interface which is a part of the cartomiser 3 that interfaces with the main housing 2 (or aerosol-generating device). In the above example, the device interface may include the metal cap 8 including the bottom wall 81 and circumferential side wall 83 and/or the lower support unit 7 including the bottom surface 72. More generally, the device interface of the cartomiser 3 may encompass any part or parts of the cartomiser 3 that contact, abut, engage or otherwise couple to the main housing 2.

When the components of the cartomiser 3 have been assembled together, an overall air passage exists from the bottom end 32 to the top end 31 of the cartomiser 3 and it is formed by the air passage 73 leading to the air passage 58 which, in turn, leads to the mouthpiece orifice 41. Where the air passage 73 meets the air passage 58, the air flow bifurcates as it passes around the side edges of the heater assembly 6.

With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

In addition, when the components of the cartomiser 3 have been assembled, the heater assembly 6 is arranged such that the ends thereof are in fluid communication with the wells 53 (or openings to the wells 53). Liquid aerosol-generating material in the reservoir 46 is therefore able to pass to the ends of the heater assembly 6 via the wells 53. Liquid aerosol-generating material is also permitted to travel along the longitudinal direction of the heater assembly 6, e.g., to regions of the heater assembly 6 that are not in direct contact with the reservoir 46, such as a region of the heater assembly that is provided in the air passage 73 or air passage 58. Any suitable arrangement may be provided to facilitate the transfer of liquid along the longitudinal direction. For example, in some implementations, a wicking material, such as cotton or glass fibres, formed as a layer may be provided between the heater assembly 6 and the upper clamping unit 5, where the wicking material is in contact with the wells 53 and capable of transporting the liquid aerosol-generating material in the longitudinal direction. Additionally or alternatively, the heater assembly 6 itself may be formed with one or more channels permitting the transport of liquid aerosol-generating material along the length of the heater assembly 6. For example, in some implementations, the heater assembly 6 may be formed from a porous substrate (such as a sintered material or a ceramic) and/or have channels formed (such as through drilling or other machining) along the length of the heater assembly 6. Accordingly, even though only a part of the heater assembly 6 in FIG. 2 is shown in contact with the wells 53, liquid is capable of travelling along the length of the heater assembly.

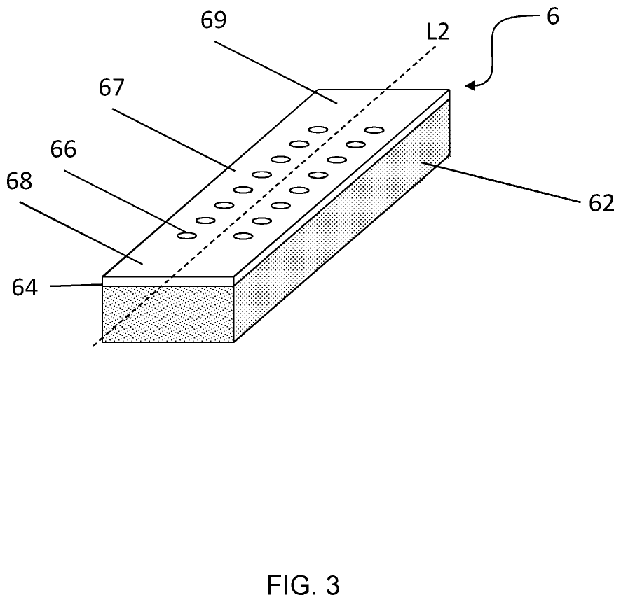

Turning now to the heater assembly 6, the heater assembly 6 is a microfluidic heater assembly. FIG. 3 illustrates the microfluidic heater assembly 6 in more detail.

The microfluidic heater assembly 6 comprises a substrate 62 and an electrically resistive layer 64 disposed on a surface of the substrate 62.

In this implementation, the substrate 62 is formed from a non-conductive material, such as quartz (silicon dioxide); however, it should be appreciated that other suitable non-conductive materials may be used, such as ceramics or silicon oxide, for example. As noted above, the substrate 62 in some implementations may be formed from a porous material. The porous substrate 62 may be formed from naturally porous materials, such as sponges, porous stones or ceramics etc., or via materials that are engineered to be porous, such as sintered metals or other materials. These materials, either formed naturally or engineered, have pores or hollow regions which are interconnected and define passages that follow a substantially random pathway through the material. In other implementations, the substrate 62 may be considered substantially impermeable. The way in which the substrate 62 is formed and the materials it is made therefrom is not of primary significance to the principles of the present disclosure.

The electrically resistive layer 64 is formed from any suitable electrically conductive material, for example a metal or a metal alloy such as titanium or nickel chromium. The electrically resistive layer 64 may be formed on the surface of the substrate 62 in any suitable way. For example, the electrically resistive layer 64 may be provided as a film that is adhered or otherwise bonded to the surface of the substrate 62. Alternatively, the electrically resistive layer 64 may be formed though a deposition technique, such as chemical or vapour deposition. The way in which the electrically resistive layer 64 is formed and the materials it is made therefrom is not of primary significance to the principles of the present disclosure.

The heater assembly 6 is planar and in the form of a rectangular cuboidal block, elongate in the direction of a longitudinal axis L2. The heater assembly 6 has the shape of a strip and has parallel sides. The planar heater assembly 6 has parallel upper and lower major (planar) surfaces and parallel side surfaces and parallel end surfaces. In the shown implementation of FIG. 3, the length of the heater assembly 6 is 10 mm, its width is 1 mm, and its thickness is 0.12 mm (where the thickness of the substrate 62 is approximately 0.10 mm, and the thickness of the electrically resistive layer 64 is approximately 0.02 mm). The small size of the heater assembly 6 enables the overall size of the cartomiser 3 to be reduced and the overall mass of the components of the cartomiser 3 to be reduced. However, it should be appreciated that in other implementations, the heater assembly 6 may have different dimensions depending upon the application at hand. For example, in some implementations, the heater assembly 6 may be a 3×3 mm chip.

Along the longitudinal axis L2, the heater assembly 6 has a central portion 67 and first and second end portions 68, 69. In FIG. 3, the length of the central portion 67 (relative to the lengths of the end portions 68, 69) has been exaggerated for reasons of visual clarity. When the vaporizer is in situ in the cartomiser, the central portion 67 is positioned in the air passage 73. The central portion 67 extends across the top end of the air passage 73 of the lower support unit 7, and across the bottom end of the air passage 58 of the upper clamping unit 5. The end portions 68, 69 are clamped between the upper clamping unit 5 and the lower support unit 7.

In the central portion 67 of the heater assembly 6, a plurality of capillary tubes 66 are provided. Only the openings of the capillary tubes 66 are shown in FIG. 3 (and in an exaggerated way for clarity), but the capillary tubes 66 extend from one side of the heater assembly 6 to the other. More specifically, the capillary tubes extend from the side of the heater assembly 6 opposite the electrically resistive layer 64 (the largest surface not shown in FIG. 3), through the substrate 62 toward the face of the substrate 62 on which the electrically resistive layer 64 is disposed, and then through the electrically resistive layer 64. The plurality of capillary tubes 66 extend substantially linearly through the heater assembly 6 (that is, the capillary tubes 66 follow substantially linear paths). By substantially, it is meant that the capillary tubes 66 follow pathways that are within 5%, within 2% or within 1% of a straight line. This measure may be obtained in any suitable way, e.g., by comparison of the length of the distance from a first point to a second point along the extent of the capillary tube 66 and the corresponding distance that the central axis of the capillary tube 66 extends between the same two points. The capillary tubes 66 are formed in the heater assembly 66 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes that substantially follow a linear path, is laser drilling. However, any other suitable technique may be employed in order to generate the capillary tubes 66.

The capillary tubes 66 are configured so as to transport liquid from one surface of the heater assembly 6 (i.e., the surface of the substrate 62 opposite the electrically resistive layer 64) to the electrically resistive layer 64. The capillary tubes 66 may be formed based in part on the liquid to be stored in the reservoir 46 of the cartomiser 3 and subsequently used with the heater assembly 6. For example, the properties of the liquid aerosol-generating material (e.g., viscosity) in the reservoir 46 of the cartomiser 3 may dictate the configuration of the capillary tubes 66 to ensure that a suitable flow of liquid is provided to the electrically resistive layer 64. Broadly speaking, in some implementations, the capillary tubes 66 may have a diameter on the order to tens of microns, e.g., between 10 μm to 100 μm. However, it should be appreciated that capillary tubes 66 in other implementations may be set differently.

With reference back to FIG. 2, the heater assembly 6 is shown positioned between the upper clamping unit 5 and the lower support unit 7. In particular, the heater assembly 6 is oriented such that the electrically resistive layer 64 faces towards the lower support unit 7, while the substrate 62 faces towards the upper clamping unit 5. It should be understood from FIG. 2 that the end portions 68, 69 of the heater assembly 6 overlap the through holes 74 and the contact pads 75. More specifically, the electrically resistive layer 64 is provided in contact with the contact pads 75, and therefore the end portions 68, 69 act to form an electrical connection with the contact pads 75 (and thus any power source subsequently attached to the contact pads 75, such as from the aerosol provision device 2). For example, the aerosol provision device 2 may have two power supply pins (not shown) which make contact with the bottom ends of the contact pads 75. The top ends of the contact pads 75 are in electrical contact with the heater assembly 6, as above. In use, electrical power supplied by the power supply of the aerosol provision device 2 passes through the electrically resistive layer 64, by virtue of the electrical connection between the end portions 68, 69 and the contact pads 75, to cause heating of the electrically resistive layer 64. The amount of heating achieved (i.e., the temperature of the electrically resistive layer 64 that is able to be reached) may depend in part on the power supplied by the aerosol provision device 2 and the electrical resistance of the electrically resistive layer 64. Equally, the amount of heating required (i.e., the temperature necessary to vaporise the liquid supplied to the resistive layer 64) will be dependent in part on the properties of the liquid supplied to the electrically resistive layer 64. Accordingly, the resistance of the electrically resistive layer 64 may be set based on the particular application at hand, whereby the resistance of the electrically resistive layer 64 may be dependent on the material of the electrically resistive layer 64 and the physical dimensions of the electrically resistive layer 64 (e.g., thickness).

In FIG. 3, the capillary tubes 66 are arranged in a simplified manner to explain the structure of the heater assembly 6. In particular, the capillary tubes 66 are shown as being uniformly distributed in the central portion 67 of the heater assembly 6 and as having the same diameter. However, in accordance with the present disclosure, this is not the case and the arrangement and/or configuration of the capillary tubes 66 are different in different regions of the heater assembly 6.

In particular, it has been found that, during use of the heater assembly 6, that is when an electrical current is applied to the electrically resistive layer 64 of the microfluidic heater assembly 6, the temperatures across the electrically resistive layer 64 are not uniform. That is to say, different regions of the electrically resistive layer 64 may reach higher temperatures than other regions of the electrically resistive layer 64 when operated. These regions of the electrically resistive layer 64 where the temperature is relatively higher may be referred to as “hot-spots” of the electrically resistive layer 64. These “hot-spots” may be the result of one or more features of the heater assembly 6 and/or the cartomiser 3. For example, “hot-spots” may occur due to the application of an electric current to the electrically resistive layer 64, whereby variations in the flow of current across the electrically resistive layer 64 and/or variations in the resistance of the electrically resistive layer 64 may cause certain regions of the electrically resistive layer 64 to reach greater temperatures than others. Additionally, or alternatively, “hot-spots” may occur due to a cooling effect applied to the heater assembly 6 only being applied in certain regions or only having an effect in certain regions. Such cooling effects may include the mass of liquid supplied to certain regions of the heater assembly 6, for example where a greater mass or a greater mass flow rate in certain regions of the heater assembly 6 may lead to cooling of the electrically resistive layer 64 in those regions. Alternatively, cooling may be due to the direction and/or extent of coverage of an air flow towards or in the vicinity of the heater assembly 6, whereby air flow that impinges or otherwise passes by regions of the heater assembly may help cool those regions. Subsequently, the absence or reduced effectiveness of such cooling mechanism in a particular heater assembly 6 or configuration of cartomiser 3 can lead to the formation of “hot-spots”.

With reference to the example heater assembly of FIG. 3, even excluding the end portion 68, 69 which are configured substantially for a different purpose than the central portion 67, hot-spots may appear within the central portion 67 of the heater assembly (where this central portion 67 comprises the capillary tubes 66). For the rectangular cuboid shaped heater assembly 6 described above in the configuration of the cartridge 3 as described above, hot-spots may be seen to appear within a central region of the central portion 67 of the heater assembly 6. That is to say, of the central portion 67, a central region of the central portion 67 may be at a generally higher temperature during operation than an outer or peripheral region of the central portion 67 that surrounds the central region of the central portion 67. In use, this means that, liquid that is supplied to the electrically resistive layer 64 from one capillary tube 66 may not be heated to the same extent as liquid supplied to the electrically resistive layer 64 from another capillary tube 66, where the two capillary tubes are provided in different regions of the central portion 67 of the heater assembly 6.

In accordance with the present disclosure, it has been found that liquid aerosol-generating material held in the substrate 62 (or more particularly in the capillary tubes 66 of the substrate 62) can be used as a heat-sink. In other words, a liquid aerosol-generating material, when heated, requires a certain amount of energy to vaporise that liquid aerosol-generating material. If a heater (such as the electrically resistive layer 64) provides that energy to the liquid aerosol-generating material, then that energy supplied to the aerosol-generating material does not contribute to raising the temperature of the electrically resistive layer 64 local to the liquid aerosol-generating material. Accordingly, a relative increased presence of liquid aerosol-generating material at the localised region of the electrically resistive layer 64, can exhibit a relative cooling effect at the localised region of the electrically resistive layer 64. The present disclosure utilises this principle to alter the heating characteristics of the heater assembly 6.

More specifically, in accordance with aspects of the present disclosure, within a first region of the electrically resistive layer 64, the combined area of the openings of the capillary tubes 66 per unit area of the electrically resistive layer 64 is set to be greater than the combined area of the openings of the capillary tubes 66 per unit area of the electrically resistive layer 64 in a second region of the electrically resistive layer 64. Put another way, the total area (per unit area) through which aerosol-generating material can be delivered to the electrically resistive layer 64 is greater in a first region than a second region. In this way, more liquid aerosol-generating material is able to be supplied per second to the first region than a second region—that is to say, the rate (e.g., mass per second) of delivery of aerosol-generating material to a first region is greater than the rate in a second region. The increase in liquid aerosol-generating material to the first region can thereby help to cool the electrically resistive layer 64 in the first region and subsequently remove or reduce the hot-spots and lead to more uniform heating of the aerosol-generating material.

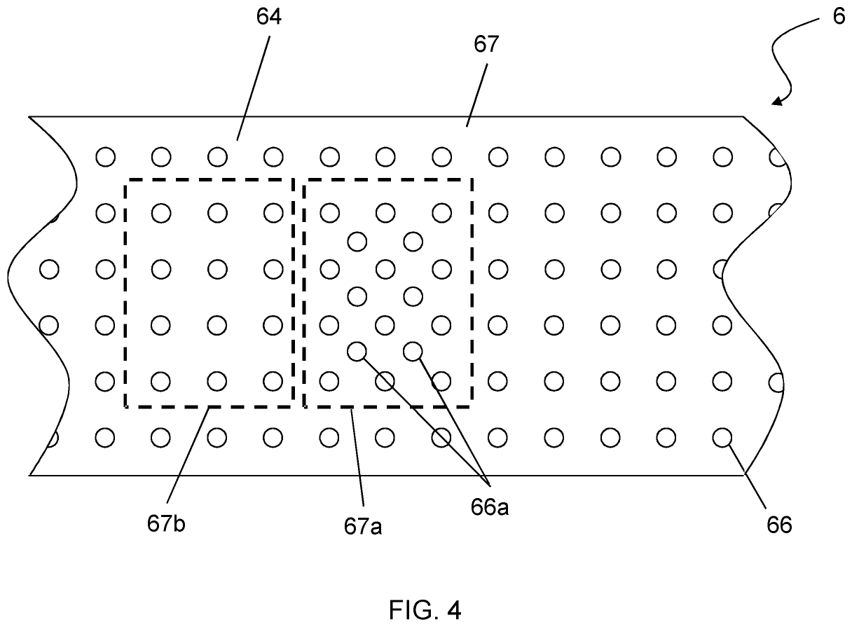

FIGS. 4 to 6 respectively represent three examples of a heater assembly 6 where the combined area of the openings of the capillary tubes 66 per unit area of the electrically resistive layer 64 in a first region is set to be greater than the combined area of the openings of the capillary tubes 66 per unit area of the electrically resistive layer 64 in a second region of the electrically resistive layer 64 according to the principles of the present disclosure. In this regard, the combined area is to be understood as a sum of the individual two-dimensional areas of the capillary tube openings as projected onto a plane that is parallel to the electrically resistive layer 64.

Each of FIGS. 4 to 6 show a part of the central portion 67 of the heater assembly 6 as viewed from above (i.e., looking down onto the electrically resistive layer 64). A plurality of capillary tubes 66 are shown across the central portion 67 of the heater assembly 6, where as above, the capillary tubes 66 extend through to the other surface of the heater assembly 6 (i.e., the surface opposite the electrically resistive layer 64).

Each of FIGS. 4 to 6 also show two regions on the electrically resistive layer 64; a first region 67a and a second region 67b. The first and second regions 67a, 67b are shown with dashed lines in FIGS. 4 to 6. For a heater assembly 6 described broadly as in FIG. 3 and cartomiser 3 as described broadly in FIGS. 1 and 2 and not implementing the teachings of the present disclosure (that is, providing the combined area of the openings of the capillary tubes 66 per unit area of the electrically resistive layer 64 in a first region to be greater than the combined area of the openings of the capillary tubes 66 per unit area of the electrically resistive layer 64 in a second region of the electrically resistive layer 64), hot-spots may occur broadly in the central region of the central portion 67 of the heater assembly 6. Accordingly, FIGS. 4 to 6 show the first region 67a which coincides with the region where such hot-spots would typically form for such a heater assembly 6. The second region 67b is shown at an arbitrary position on the central portion 67 of the heater assembly 6. In practical applications, the second region 67b is likely to surround the first region 67a (that is, the second region 67b may be present around the first region 67a).

However, it should be understood that the position of the first region 67a on the electrically resistive layer 64 may not be in the centre of a central portion 67 for all implementations. For example, depending on the specific construction of the heater assembly 6, the position of the heater assembly 6 within a cartomiser 3 and/or how the heater assembly 6 is operated, the position of the first region 67a may be defined differently. For example, if a heater assembly 6 is operated and hot spots are found to occur at the edges of the central portion 67, then the first region 67a may be defined at the edges of the central portion 67. Moreover, there may be multiple, discrete first regions 67a—for example, if the heater assembly 6 when operated exhibits hot-spots at either end of the central portion 67 (i.e., regions adjacent the end portions 68, 69 of the heater assembly), then two first regions 67a may be defined at either end of the central portion 67. FIGS. 4 to 6 are provided to show different examples of the combined area of the openings of the capillary tubes 66 per unit area of the electrically resistive layer 64 in a first region 67a being greater than the combined area of the openings of the capillary tubes 66 per unit area of the electrically resistive layer 64 in the second region 67b of the electrically resistive layer 64, and the precise location of the first region 67a will depend on the implementation at hand.

Additionally, it should be understood that the first and second regions 67a, 67b may not necessarily encompass the entirety of the region on the electrically resistive layer 64 that may experience hot-spots. That is to say, the size of the first region 67a and second region 67b are arbitrarily chosen to allow for the purposes of comparison of different parts of the electrically resistive layer 64. Because the significant feature of the present disclosure is combined area of the openings of the capillary tubes 66 per unit area of the electrically resistive layer 64, the actual area encompassed by the first or second regions 67a, 67b is irrelevant.

FIG. 4 represents a first example of a heater assembly 6 according to the present disclosure.

In FIG. 4, the first region 67a and the second region 67b are shown. A plurality of capillary tubes 66 are broadly distributed in a uniform manner across the surface of the electrically resistive layer 64 (e.g., spaced evenly in the X and Y directions, where the X and Y directions correspond to the length and width directions of the heater assembly 6). However, in the first region 67a, a plurality of additional capillary tubes 66a are provided, and more specifically, are disposed in the spaces on the electrically resistive layer 64 between the existing capillary tubes 66. In this particular implementation, if it is assumed that the capillary tubes 66 are pitched from each other by a unit of one in the X or Y directions, the additional capillary tubes 66a are positioned at units of one half in both the X and Y directions from a given capillary tube 66. The additional capillary tubes 66a also extend from one side of the heater assembly 6 to the other (i.e., from the side of the heater assembly 6 opposite the electrically resistive layer 64, through the substrate 62 toward the face of the substrate 62 on which the electrically resistive layer 64 is disposed, and then through the electrically resistive layer 64).

In the example of FIG. 4, the size of the openings of the capillary tubes 66 and the additional capillary tubes 66a are the same (that is, the diameters of the openings of the capillary tubes 66 and additional capillary tubes 66a are the same). The additional capillary tubes 66a may therefore be distinguished from the capillary tubes 66 only by virtue of their positioning relative to the uniform distribution of the capillary tubes 66 across the central portion 67 of the heater assembly 6. In summary, the example of FIG. 4 provides additional capillary tubes 66a, which are substantially identical to the capillary tubes 66, per unit area in the first region 67a as compared to the second region 67b. For example, in FIG. 4, the second region 67b encompasses twelve capillary tube openings while the first region 67a encompasses eighteen capillary tube openings. If we define the regions 67a, 67b as a unit of area (as they are both the same size in the X and Y directions), we can say that the first region 67a has six more capillary tube openings per unit area than the second region 67b. This represents a 50% increase in the number of capillary tube openings in the first region 67a as compared to the second region 67b. As the capillary tubes 66 and the additional capillary tubes 66a are the same size, we can further say that combined area of the openings of the capillary tubes 66 per unit area of the electrically resistive layer 64 in the first region 67a is 50% greater than the combined area of the openings of the capillary tubes 66 per unit area of the electrically resistive layer 64 in the second region 67b of the electrically resistive layer 64. Assuming the supply of liquid aerosol-generating material to the capillary tube openings on the lower side of the substrate 62 (i.e., the side opposite the side comprising the electrically resistive layer 64) is sufficient to supply each capillary tube opening with the same amount of liquid aerosol-generating material, then the first region 67a can be supplied with 50% more liquid aerosol-generating material than the second region 67b. Accordingly, as more liquid aerosol-generating material is supplied to the first region 67a, a relatively greater degree of cooling of the electrically resistive layer 64 in the first region 67a can be realised. Therefore, if the first region 67a would otherwise experience hot-spots in the absence of the additional capillary tubes 66a, providing the additional capillary tubes 66a can help reduce the temperature of the hot-spots and, in some implementations, may reduce the temperature such that the temperature of the electrically resistive layer 64 is uniform, at least over the central portion 67 where the majority of aerosol formation occurs.

Hence, in accordance with the example of FIG. 4 the combined area of the capillary tube openings (capillary tubes 66 and 66a) per unit area in the first region 67a is set to be greater than the combined area of the capillary tube openings (capillary tubes 66) per unit area in the second region 67b. This is achieved in FIG. 4 by increasing the number of capillary tubes 66, 66a in the first region 67a compared to the second region 67b.

It should be appreciated that the additional capillary tubes 66a shown in the first region 67a of FIG. 4 are spaced from the capillary tubes 66 in a certain manner, as described above. However, this is only an example of how the additional capillary tubes 66a may be arranged in the first region 67a. In principle, the additional capillary tubes 66a may be arranged at any spacing or pitch relative to the capillary tubes 66, and indeed any number of additional capillary tubes 66a may be provided as appropriate. Furthermore, the capillary tubes 66 are provided with the same spacing or pitch as the capillary tubes 66 in the second region 67b. However, this need not be the case, and the capillary tubes 66 within the first region 67a may be arranged in any desired manner.

It should be appreciated however that in some implementations care may need to be taken in respect of the amount of electrically resistive layer 64 that is present between the capillary tube openings. The spacing between capillary tube openings may influence the resistance of the electrically resistive layer 64 in the space between the capillary tube openings. In particular, if the capillary tube openings are close to one another, the electrical resistance of the electrically resistive layer 64 may be relatively increased in this localised region. Generally, the electrical resistance of a conductor (such as a wire) is inversely proportional to the cross-sectional area of the conductor (broadly in the direction along which current flows). Accordingly, providing a decreased cross-sectional area of the electrically resistive layer 64 in the regions between capillary tubes 66 may increase the electrical resistance in that region. Furthermore, it is generally understood that electrical power dissipated by a conductor (which may be dissipated as heat) is proportional to the applied current (squared) and the resistance of the conductor. Hence, this could lead to the localised region of the electrically resistive layer 64 between the capillary tubes 66 reaching a relatively higher temperature when a current is applied thereto, and therefore requiring a greater amount of liquid to act as a heat-sink to help reduce the temperature at the electrically resistive layer 64. Thus, a balance may need to be struck between increasing the amount of liquid aerosol-generating material provided to the electrically resistive layer 64 in a first region 67a to provide a cooling effect versus increasing the (local) electrical resistance of the electrically resistive layer 64 in the first region 67a which may act to increase the temperature. The desired or required capillary tube 66, 66a distribution in the heater assembly 6 in the first region 67a may be found through empirical testing or computer modelling.

Furthermore, it should be understood that in view of the above, in some implementations, it may be possible to alter the electrical properties of the electrically resistive layer 64 in the regions between capillary tubes 66 and additional capillary tubes 66a. For example, it may be possible to compensate for any reduction in the cross-sectional area of the electrically resistive layer 64 between capillary tubes 66 in the width direction (i.e., in the direction between the capillary tubes 66) by increasing the thickness of the electrically resistive layer 64 in that region. (That is, one may offset, at least partially, the reduction in width by an increase in thickness to alter the cross-sectional area, which is the product of the width and thickness; for example, this may be to keep the cross-sectional area constant). As should be appreciated from above, increasing the thickness of the electrically resistive layer 64 decreases the electrical resistance of the electrically resistive layer 64. Increasing the thickness of the electrically resistive layer 64 may be achieved by depositing additional material at the relevant location on the surface of the electrically resistive layer 64, for example, although any suitable technique may be used.

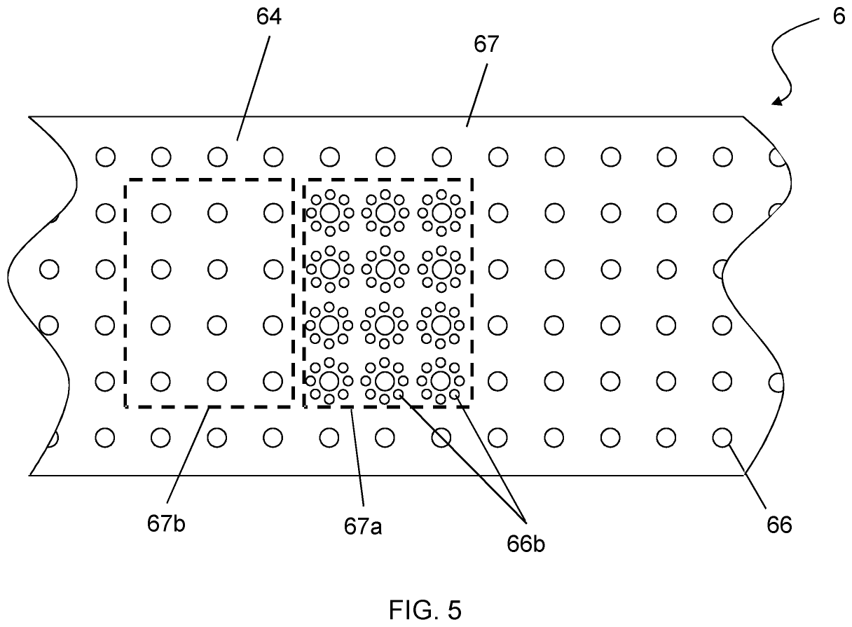

FIG. 5 represents a second example of a heater assembly 6 according to the present disclosure.

In FIG. 5, the first region 67a and the second region 67b are shown as before. Additionally, a plurality of capillary tubes 66 are broadly distributed in a uniform manner across the surface of the electrically resistive layer 64 (e.g., spaced evenly in the X and Y directions, where the X and Y directions correspond to the length and width directions of the heater assembly 6). However, in the first region 67a, a plurality of smaller capillary tubes 66b are also provided, and more specifically, are disposed circumferentially around the outside of the existing capillary tubes 66. In this particular implementation, eight smaller capillary tubes 66b are provided circumferentially around each capillary tube 66. The smaller capillary tubes 66b also extend from one side of the heater assembly 6 to the other (i.e., from the side of the heater assembly 6 opposite the electrically resistive layer 64, through the substrate 62 toward the face of the substrate 62 on which the electrically resistive layer 64 is disposed, and then through the electrically resistive layer 64).

In the example of FIG. 5, the size of the openings of the capillary tubes 66 and the smaller capillary tubes 66b are different (that is, the diameters of the openings of the capillary tubes 66 are different, specifically larger, than the diameters of the smaller capillary tubes 66b). In a similar manner to the example described in FIG. 4, the example of FIG. 5 provides a greater number of capillary tubes 66 and 66b per unit area in the first region 67a as compared to the second region 67b. However, unlike FIG. 4, the openings of the smaller capillary tubes 66b are smaller than the openings of the capillary tubes 66, and hence the area of the opening of an individual smaller capillary tubes 66b is less than the area of the opening of a capillary tube 66. If it is assumed, simply for the purposes of providing an example calculation, that the area of the opening of a smaller capillary tube 66b is one eighth the area of the opening of the capillary tube 66, then the combined area of the first region 67a is twice that of the second region 67b (where the second region 67b contains twelve capillary tubes 66 and the first region contains twelve capillary tubes 66 and 96 small capillary tubes 66b, which is the equivalent combined area of twelve capillary tubes 66 (i.e., 96 multiplied by one eighth)). This represents a 100% increase in the combined area of the openings of the capillary tubes (capillary tubes 66 and small capillary tubes 66b) per unit area of the electrically resistive layer 64 in the first region 67a as compared to the second region 67b. As before, assuming the supply of liquid aerosol-generating material to the capillary tube openings on the lower side of the substrate 62 (i.e., the side opposite the side comprising the electrically resistive layer 64) is sufficient to supply each capillary tube opening with the same amount of liquid aerosol-generating material, then the first region 67a can be supplied with 100% more liquid aerosol-generating material than the second region 67b. Accordingly, as more liquid aerosol-generating material is supplied to the first region 67a, a relatively greater degree of cooling of the electrically resistive layer 64 in the first region 67a can be realised as described above in FIG. 4.

Hence, in accordance with the example of FIG. 5 the combined area of the capillary tube openings (capillary tubes 66 and 66b) per unit area in the first region 67a is set to be greater than the combined area of the capillary tube openings (capillary tubes 66) per unit area in the second region 67b. This is achieved in FIG. 5 by increasing the number of capillary tubes 66, 66b in the first region 67a compared to the second region 67b.

More generally, the example of FIG. 5 can be understood to provide a first group of capillary tubes (i.e., capillary tubes 66) each extending to openings of a first size and a second group of capillary tubes (i.e., capillary tubes 66b) each extending to openings of a second size, smaller than the first size. The first region 67a of the heart assembly 6 contains relatively more of the second group of capillary tubes 66b than the second region 67b. In the example of FIG. 5, the second region 67b contains no capillary tubes 66b of the second group of capillary tubes 66b. That is to say, the second group of capillary tubes 66b are provided only in the first region 67a, with the second group of capillary tubes 66b distributed around the openings of the first group of capillary tubes 66 in the first region 67a. However, but it should be understood that this may not be the case for all implementations, and in some implementations, the second region 67b may include some of the second group of capillary tubes 66b.

Additionally, in the described example of FIG. 5, in the first region 67a, the number of capillary tubes 66b in the second group of capillary tubes 66b is greater than the number of capillary tubes 66 in the first group of capillary tubes 66. That is to say, each of the first capillary tubes 66 is provided with a plurality of smaller capillary tubes 66b positioned around the opening of the capillary tube 66 (and in the specific example of FIG. 5, this is eight small capillary tubes 66b for each capillary tube 66). This may help provide an improved cooling effect without significantly impacting on the electrical resistance of the electrically resistive layer 64. However, it should be understood that this may not be the case in all implementations, and the smaller capillary tubes 66b may be provided in a one-to-one (or less) relationship with the capillary tubes 66. Additionally, as with the implementation described in FIG. 4, the electrical properties of the electrically resistive layer 64 in the regions between capillary tubes 66 and small capillary tubes 66b may be altered, if desired.

It should be appreciated that the small capillary tubes 66b shown in the first region 67a of FIG. 5 are spaced from the capillary tubes 66 in a certain manner, as described above. However, this is only an example of how the small capillary tubes 66b may be arranged in the first region 67a. In principle, the small capillary tubes 66b may be arranged at any spacing or pitch relative to the capillary tubes 66, and indeed any number of small capillary tubes 66b may be provided as appropriate.

Furthermore, the capillary tubes 66 are provided with the same spacing or pitch as the capillary tubes 66 in the second region 67b. That is to say, the first group of capillary tubes 66 are uniformly distributed through the first and second regions 67a, 67b. However, this need not be the case, and the capillary tubes 66 within the first region 67a may be arranged in any desired manner. The desired or required capillary tube 66, 66b distribution in the heater assembly 6 in the first region 67a may be found through empirical testing or computer modelling.

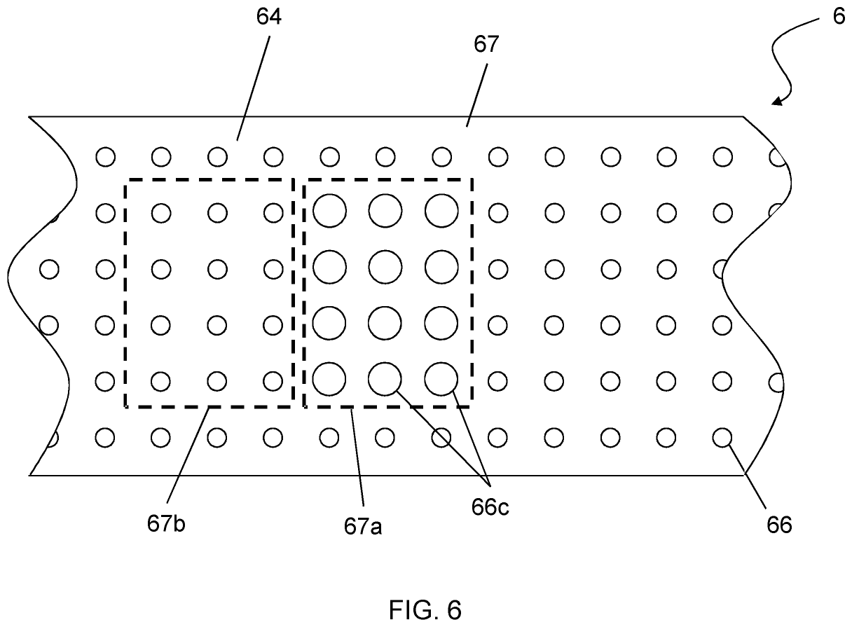

FIG. 6 represents a third example of a heater assembly 6 according to the present disclosure.

In FIG. 6, the first region 67a and the second region 67b are shown as before. In this example, a plurality of capillary tubes 66 are distributed in a uniform manner across the surface of the electrically resistive layer 64 in the second region 67b. However, in the first region 67a, larger capillary tubes 66c are provided, whereby the capillary tubes 66c have a larger size (i.e., opening) than the capillary tubes 66. The larger capillary tubes 66c also extend from one side of the heater assembly 6 to the other (i.e., from the side of the heater assembly 6 opposite the electrically resistive layer 64, through the substrate 62 toward the face of the substrate 62 on which the electrically resistive layer 64 is disposed, and then through the electrically resistive layer 64).

In the example of FIG. 6, the size of the openings of the capillary tubes 66 and the larger capillary tubes 66c are different (that is, the diameters of the openings of the capillary tubes 66 are different, specifically smaller, than the diameters of the larger capillary tubes 66c). Unlike the examples of FIGS. 4 and 5, in FIG. 6 the number of larger capillary tubes 66c per unit area in the first region 67a is the same as the number of capillary tubes 66 in the second region 67b. However, while the number of capillary tubes in each of the first and second region is the same, the combined area is different. The openings of the larger capillary tubes 66c are greater than the openings of the capillary tubes 66, and hence the area of the opening of an individual larger capillary tube 66c is greater than the area of the opening of a capillary tube 66. If it is assumed, simply for the purposes of providing an example calculation, that the area of the opening of a larger capillary tube 66c is 1.5 times greater the area of the opening of the capillary tube 66, then this represents a 50% increase in the combined area of the openings of the capillary tubes (larger capillary tubes 66c) per unit area of the electrically resistive layer 64 in the first region 67a as compared to the combined area of the openings of the capillary tubes in the second region 67b. As before, assuming the supply of liquid aerosol-generating material to the capillary tube openings on the lower side of the substrate 62 (i.e., the side opposite the side comprising the electrically resistive layer 64) is sufficient to supply each capillary tube opening with the same amount of liquid aerosol-generating material, then the first region 67a can be supplied with 50% more liquid aerosol-generating material than the second region 67b. Accordingly, as more liquid aerosol-generating material is supplied to the first region 67a, a relatively greater degree of cooling of the electrically resistive layer 64 in the first region 67a can be realised as described above in FIG. 4 and FIG. 5.

Hence, in accordance with the example of FIG. 6 the combined area of the capillary tube openings (capillary tubes 66c) per unit area in the first region 67a is set to be greater than the combined area of the capillary tube openings (capillary tubes 66) per unit area in the second region 67b. This is achieved in FIG. 6 by increasing the size (diameter) of the capillary tubes 66c in the first region 67a compared to the size of the capillary tubes in the second region 67b. 3. In particular, the size of each of the openings of the capillary tubes 66c in the first region 67a is greater than the size of each of the openings of the capillary tubes 66 in the second region 67b.

Furthermore, the capillary tubes 66c are provided with the same spacing or pitch as the capillary tubes 66 in the second region 67b. However, this need not be the case, and the capillary tubes 66c within the first region 67a may be arranged in any desired manner. The desired or required capillary tube 66, 66c distribution in the heater assembly 6 in the first region 67a may be found through empirical testing or computer modelling.

Additionally, as with the implementation described in FIG. 4, should the electrical properties of the electrically resistive layer 64 between the larger capillary tubes 66c be adversely affected by the presence of the larger capillary tubes 66c, then the electrical properties of the electrically resistive layer 64 in the regions between the large capillary tubes 66c and/or between the large capillary tubes 66c and capillary tubes 66 may be altered, if desired.

Hence, it has been described that relative cooling of localised areas of the electrically resistive layer 64 can be achieved by setting the combined area of the openings of the capillary tubes 66 per unit area of the electrically resistive layer 64 in a first region 67a (corresponding to at least a part of a region where a hot-spot would otherwise be observed) to be greater than the combined area of the openings of the capillary tubes 66 per unit area of the electrically resistive layer 64 in a second region of the electrically resistive layer 64. This, broadly, has been shown to be achieved by: providing additional capillary tubes 66a of the same size (i.e. having the same area of the openings of the capillary tubes) as the capillary tubes 66 distributed across the heater assembly 6; providing additional capillary tubes 66b of a smaller size (i.e. having a smaller area of the openings of the capillary tubes) as the capillary tubes 66 distributed across the heater assembly 6; or by changing the size of the capillary tubes 66c (i.e. the area of the openings of the capillary tubes) in a first region 67a relative to the size of the capillary tubes 66 in a second region 67b. However, it should be appreciated that FIGS. 4 to 6 represent a non-exhaustive list of possible ways in which the combined area of the openings of the capillary tubes 66 per unit area may be changed or set to be different in different regions of the heater assembly 6. For example, the relative shape(s) of the capillary tubes 66 may also be changed (i.e., different in the different regions) to alter the area of the openings.

It should be appreciated that a cartomiser 3 (or more generally an aerosol provision system 1) employing the heater assembly 6 as described above may have the heater assembly 6 configured in any suitable manner to achieve the desired thermal property of the heater assembly in use (e.g., the creation or enhancement of hot-spots, or the more uniform operational temperature across the electrically resistive layer 64 of the heating assembly 6). As described above, several factors may dictate the appearance of hot-spots. On the one hand, these factors may be intrinsic to the heater assembly 6. For example, the local resistance(s) of the electrically resistive layer 64 and/or the amount (mass) of liquid held (or capable of being held) locally in different regions of the heater assembly 6. On the other hand, these factors may be external to the heater assembly 6 and be a feature of the cartomiser 3 (or aerosol provision system 1) itself. For example, as described above, the specific air flow direction and/or extent on or around the heater assembly 6 may lead to the generation of hot-spots. Additionally, if present, the wicking element (or more generally a (liquid) aerosol-generating material transport mechanism) may be configured, deliberately or otherwise, to supply liquid aerosol-generating material at different rates to different regions of the heater assembly 6. Accordingly, it should be understood that these external factors may influence the location(s) of the first and second regions 67a, 67b of heater assembly 6. Put another way, the heater assembly 6 is configured to provide the first and second regions 67a, 67b at suitable locations of the heater assembly 6 based on the external factors governed by the cartomiser 3 (or aerosol provision system 1) the heater assembly 6 is to be used in.

Therefore, in accordance with one aspect of the present disclosure, an aerosol provision system 1 comprises a heater assembly 6 (as described above) and an air inlet (such as air inlet hole 22) configured to direct a flow of air (generated by a user inhaling on the mouthpiece 33 of the aerosol provision system 1) towards the heater assembly 6 such that, in use, the cooling effect of said flow of air on the heater assembly 6 is greater in the second region 67b compared to a cooling effect of said air flow on the heater assembly 6 in the first region 67a. Accordingly, in such implementations, the combined area of the openings per unit area of the electrically resistive layer 64 in the first region 67a of the electrically resistive layer 64 is set to be greater than the combined area of the openings per unit area of the electrically resistive layer 64 in a second region 67b of the electrically resistive layer 64. In such implementations, the reduced impact of cooling from the air flow in the first region 67a (as compared to the effectiveness of the cooling from the air flow in the second region 67b) can be offset by increasing the relative amount (mass) of liquid stored in the first region 67a by increasing the combined area of the openings per unit area of the electrically resistive layer 64 in the first region 67a of the electrically resistive layer 64.

Additionally, or alternatively, in accordance with another aspect of the present disclosure, an aerosol provision system 1 comprises a heater assembly 6 (as described above) and a (liquid) aerosol-generating material transport mechanism (such as the wicking element/material described above). The aerosol-generating material transport mechanism is arranged so as to provide the (liquid) aerosol-generating material at a first rate to the first region 67a of the heater assembly 6 and to supply (liquid) aerosol-generating material at a second rate to a second region 67b of the heater assembly 6, where the first rate is slower than the second rate. Accordingly, in such implementations, the combined area of the openings per unit area of the electrically resistive layer 64 in the first region 67a of the electrically resistive layer 64 is set to be greater than the combined area of the openings per unit area of the electrically resistive layer 64 in a second region 67b of the electrically resistive layer 64. In such implementations, the reduced impact of cooling from the (relatively low) supply of liquid aerosol-generating material in the first region 67a (as compared to the effectiveness of the cooling from the relative high supply of liquid in the second region 67b) can be offset by increasing the relative amount (mass) of liquid stored in (or capable of being stored in) the first region 67a by increasing the combined area of the openings per unit area of the electrically resistive layer 64 in the first region 67a of the electrically resistive layer 64. That is, the low flow rate of liquid aerosol-generating material to the first region 67a can be offset by increasing the combined area of the openings per unit area of the electrically resistive layer 64 in the first region 67a.

It should be appreciated that the relative improvements in cooling performance as described in the examples of FIGS. 4 to 6 above assume that the rate of delivery of liquid aerosol-generating material is the same regardless of the size (area) of the openings of the capillary tubes 66b and 66c. However, this may not necessarily be the case, and the actual relative cooling effect may be greater than or less than given in the above examples to the extent that the rate of delivery is affected by the size (area) of the openings of the capillary tubes 66b, 66c.

Alternatively, the present disclosure may be framed as providing a heater assembly 6 in which the open surface area (per unit area) of the heater layer 64 in a first region 67a is greater than the open surface area (per unit area) of the heater layer 64 in a second region 67b. By open surface area, it is meant the surface area of the heater layer 64 in a first or second region 67a, 67b which is open (i.e., is formed by the openings of the capillary tubes). Yet further alternatively, the inverse of the open surface area, i.e., that surface area of the first or second region which is occupied by the electrically resistive layer 64—herein referred to for simplicity as the closed surface area—may be set such that the closed surface area (per unit area) of the heater layer 64 in a first region 67a is less than the closed surface area (per unit area) of the heater layer 64 in a second region 67b.

In addition, it is noted that not only is the combined area of the openings of the capillary tubes 66 in the first and second regions 67a, 67b different, but as the capillary tubes extend through the heater assembly 6, the density of the heater assembly 6 in a first volume extending from the first region 67a (i.e., in a direction along the extent of the capillary tubes 66) is less than the density of the heater assembly 6 in a second volume extending from the second region 67b. That is, because more material is removed from the heater assembly 6 in a volume corresponding to the first region 67a to form the larger or additional capillary tubes 66a, 66b, 66c, the relative density (e.g., kg/m3) of the volume corresponding to the first region 67a is therefore less. Although the relative density is less, it should be appreciated that the open capillary tubes allow relatively more liquid aerosol-generating material to pass to the electrically resistive layer 64, as discussed above.

The first and second regions 67a, 67b as described above are intended to be applied to regions of the heater assembly 6 that comprise one or more capillary tubes 66. In other words, the regions are not intended to be applied to the end portions 68, 69 of the heater assembly shown in FIG. 3, for example. Put more broadly, each of the regions 67a, 67b has a non-zero combined area of the openings of the capillary tubes 66.

Additionally, in some implementations, the regions 67a, 67b, for the purposes of comparison, do not extend beyond the bounds of the region in which the capillary tubes 66 are provided in the heater assembly 6. For example, heater assembly 6 of FIG. 3 includes a central portion 67 in which the capillary tubes 66 are distributed, in addition to the end portions 68 and 69 which do not include any capillary tubes 66. A boundary may be defined which is the boundary of the smallest area on the surface of the electrically resistive layer 64 that encompasses all of the capillary tubes 66 (and/or capillary tubes 66a, 66b, 66c) provided in the heater assembly 6. No part of the first and second regions 67a, 67b may encompass an area that exists outside of that boundary.

Additionally or alternatively, while the above has described a first and second region 67a, 67b, it should be appreciated that there may be multiple regions provided, each of the regions having a different combined area of the openings of the capillary tubes 66 per unit area. For example, a third region may be provided which surrounds the second region, whereby the third region has a smaller combined area of the openings of the capillary tubes 66 per unit area of the electrically resistive layer 64 compared to the second region 67b. The third region may also be defined as a region which does not include any capillary tubes (e.g., as a region encompassing the end portions 68, 69 of the heater assembly 6).

The heater assembly 6 as described above is generally provided as a relatively small component having a relatively small footprint (as compared to more traditional heater assemblies, such as a wick and coil). This is in part due to the fact the capillary tubes 66 are formed via a manufacturing process in the heater assembly 6 (i.e., the capillary tubes are engineered, e.g., through a laser drilling process), and can therefore be designed to achieve a desired delivery of liquid aerosol-generating material to the electrically resistive layer 64. By providing a smaller component, material wastage (e.g., when the cartomiser 3 is disposed of) can be reduced.

Not only can the liquid be provided more efficiently to the electrically resistive layer 64, but by manufacturing the capillary tubes 66, more control is given over the supply of liquid to the electrically resistive layer 64 (that is, the more capillary tubes of a certain diameter, the more liquid per unit time (ml/s) can be delivered to the electrically resistive layer 64).

It should be appreciated that the configuration of the cartomiser 3 accommodating the heater assembly 6 is provided as an example configuration of such a cartomiser 3. The principles of the present disclosure apply equally to other configurations of the cartomiser 3 (for example, comprising similar or different components to those as shown in FIGS. 1 and 2, and a similar or different layout to that shown in FIG. 2). That is, the cartomiser 3 and the relative position of the heater assembly 6 in the cartomiser 3 is not significant to the principles of the present disclosure. Broadly speaking, a cartomiser is likely to comprise a top end (having the mouthpiece orifice 41) and a bottom end. In the examples shown above, the heater assembly 6 is arranged to be below the reservoir 46, substantially horizontal to the longitudinal axis of the cartomiser 3, and arranged in an airflow path that is substantially perpendicular to longitudinal axis of the heater assembly. However, this need not be case, and in other implementations the cartomiser 3 may be configured differently depending on the particular design and application at hand. For example, the heater assembly 6 may be arranged such that airflow is substantially parallel to the longitudinal axis of the heater assembly, e.g., along the exposed surface of the electrically resistive layer 64. For example, the upper clamping unit 5 may not be provided with the central air passage 58 and instead the air passage may be provided to one side of the upper clamping unit 5. Air may enter the cartomiser 3 by a suitable inlet and flow along the longitudinal surface of the heater assembly 6 (and along the electrically resistive layer 64) before passing in a substantially vertical direction through the air passage 58 positioned at one end of the upper sealing unit 5 (e.g., the end opposite the air inlet). The outer housing 4 and mouthpiece orifice 41 may be suitably configured. In such an example, the entirely of the lower surface of the heater assembly 6 may be exposed to the reservoir 46. In such implementations, the capillary tubes 66 may be disposed across the heater assembly 6, not just within the central portion 67 of the heater assembly 6 (provided the electrically resistive layer 64 is capable of coupling to a power source). Hence, although the heater assembly 6 has been described in the specific context of the example cartomiser 3 of FIGS. 1 and 2, the principles described herein can be applied to different heater assemblies for use in different cartomisers 3.

In the example shown in FIG. 2, the contact pads 75 directly contact the electrically resistive layer 64 of the heater assembly 6. However, the cartomiser 3 may be provided with any suitable arrangement that facilitates the electrical contact between the aerosol provision device 2 and the heater assembly 6. For example, in some implementations, electrical wiring or other electrically conductive elements may extend between the electrically resistive layer 64 and the contact pads 75 of the cartomiser 3. This may particularly be the case when the heater assembly 6 has its largest dimension (e.g., its length) less than a minimum distance between the contact pads 75. The distance between the contact pads 75 may be dictated by the electrical contacts on the aerosol provision device 2.

In addition, in the described examples, the heater assembly 6 is orientated such that the electrically resistive layer 64 faces towards the bottom of the cartomiser 3. However, the orientation of the heater assembly 6 is not limited to this and, in other implementations, the heater assembly 6 may be provided in alternative orientations, for example, where the electrically resistive layer faces away from the bottom of the cartomiser 3.

It should also be appreciated that while the above has described a cartomiser 3 which includes the heater assembly 6, in some implementations the heater assembly 6 may be provided in the aerosol provision device 2 itself. For example, the aerosol provision device 2 may comprise the heater assembly 6 and a removable cartridge (containing a reservoir of liquid aerosol-generating material). The heater assembly 6 is provided in fluid contact with the liquid in the cartridge (e.g., via a suitable wicking element or via another fluid transport mechanism). Alternatively, the aerosol provision device 2 may include an integrated liquid storage area in addition to the heater assembly 6 which may be refillable with liquid. More broadly, the aerosol provision system (which encompasses a separable aerosol provision device and cartomiser/cartridge or an integrated aerosol provision device and cartridge) includes the heater assembly.

Additionally, the above has described a heater assembly 6 in which an electrically resistive layer 64 is provided on a surface of the respective substrate. In the aerosol provision system 1 of FIG. 2, electrical power is supplied to the electrically resistive layer 64 via the contact pads 75. Accordingly, an electrical current is able to flow through the electrically resistive layer 64 from one end to the other to cause heating of the electrically resistive layer 64. However, it should be understood that electrical power for the purposes of causing the electrically resistive layer 64 to heat may be provided via an alternative means, and in particular, via induction. In such implementations, the aerosol provision system 1 is provided with a coil (known as a drive coil) to which an alternating electrical current is applied. This subsequently generates an alternating magnetic field. When the electrically resistive layer 64 is exposed to the alternating magnetic field (and it is of sufficient strength), the alternating magnetic field causes electrical current (Eddy currents) to be generated in the electrically resistive layer 64. These currents can cause Joule heating of the electrically resistive layer 64 owing to the electrical resistance of this layer 64. Depending on the material which the electrically resistive layer 64 is formed, heating may additionally be generated through magnetic hysteresis (if the material is ferro- or ferrimagnetic). More generally, the electrically resistive layer 64 is an example of a heater layer of the heater assembly 6 which is configured to generate heat when supplied with energy (e.g., electrical energy), which, for example, may be provided through direct contact or via induction. Additional ways of causing the heater layer to generate heat are also considered within the principles of the present disclosure.

Moreover, it should be understood that in some implementations, an additional layer or layers, e.g., serving as a protective layer, may be disposed on top of the electrically resistive layer 64. In such implementations, the capillary tubes 66 still extend to an opening on the electrically resistive layer 64 but may additionally extend through the additional layer(s). More broadly, the capillary tubes 66 extend through the heater assembly 6 to an opening at a surface of a side of the heater assembly 6 comprising the electrically resistive layer 64, which includes an opening in the electrically resistive layer 64 itself as well as an opening in any additional layer(s) positioned above the electrically resistive layer 64.

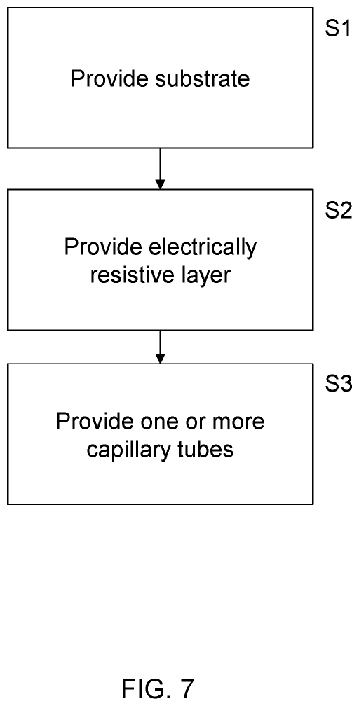

FIG. 7 depicts an example method for manufacturing a heater assembly 6.

The method begins at step S1 by providing a substrate 62. The way in which the substrate 62 is formed is not significant to the principles of the present disclosure. For example, the substrate 62 may be cut from a portion of cultured quartz or formed via a sintering process by sintering quartz powders/fibres, for example.

The method then proceeds to step S2 whereby the electrically resistive layer 64 is provided on a surface of the substrate 62. The way in which the electrically resistive layer 64 is formed on the surface of the substrate 62 is not significant to the principles of the present disclosure. For example, the electrically resistive layer 64 may be a sheet of metal (e.g., titanium) adhered, welded, or the like to the substrate 62. Alternatively, the electrically resistive layer 64 may be formed through a vapour or chemical deposition technique using the substrate 62 as a base.

It should also be appreciated that step S2 may alternatively occur before step S1. For example, a further alternative is to grow or culture the substrate 62 using the electrically resistive layer 64 as a base.

In the described example, after step S2, the method proceeds to step S3. At step S3, one or more capillary tubes 66 are formed in the substrate 62/electrically resistive layer 64. As noted above, the capillary tubes 66 extend from a surface of the substrate 62/heater assembly 6, through the electrically resistive layer 64 provided on the first surface of the substrate 62. That is, the capillary tubes 66 extend all the way through the heater assembly 6. The capillary tubes 66 may be formed by laser drilling, as noted above, or any other suitable technique.

Moreover, in accordance with the present disclosure, step S3 includes forming the one or more capillary tubes 66 in the first region 67a and the second region 67b. As noted above, the combined area of the openings of the capillary tubes 66 per unit area in the first region 67a is set to be larger than the combined area of the openings of the capillary tubes 66 per unit area in the second region 67b. This may involve drilling (or otherwise forming) the capillary tubes 66c in the first region 67a with an opening having a larger diameter (area), or it may involve providing additional capillary tubes 66a, 66b in the first region 67a with an opening of an equal or smaller diameter (area), as described above.

It should be appreciated that step S3 may be performed prior to step S2 (and equally step S3 may follow step S1 where step S2 is performed prior to step S1). That is to say, the capillary tubes 66 may be formed in the substrate 62 prior to applying the electrically resistive layer 64.

Broadly, it should be understood that the method of FIG. 7 is an example method only, and adaptations to the steps or ordering of the steps of this method are contemplated within this disclosure, for example, as described above.

After step S3, the heater assembly 6 is formed, and subsequently may be assembled to form the cartomiser 3 (or more generally, the heater assembly 6 may be positioned in an aerosol provision system 1).

Thus, there has been described a heater assembly for an aerosol provision system, the heater assembly including: a substrate; a heater layer configured to generate heat when supplied with energy, the heater layer provided on a first surface of the substrate; and a plurality of capillary tubes extending from another surface of the substrate through the heater layer provided at the first surface of the substrate. Each of the capillary tubes extends to respective openings provided in the heater layer, and the combined area of the openings per unit area of the heater layer in a first region of the heater layer is greater than the combined area of the openings per unit area of the heater layer in a second region of the heater layer. Also described is an aerosol provision system comprising a heater assembly and a method for manufacturing a heater assembly.

Alternatively, the present disclosure may be summarised as providing a heater assembly for an aerosol provision system, the heater assembly comprising: a substrate 62; a heater layer 64 configured to generate heat when supplied with energy, the heater layer 64 provided on a first surface of the substrate 62; and a plurality of capillary tubes 66 extending from another surface of the substrate 62 through the heater layer 64 provided at the first surface of the substrate 62, wherein each of the capillary tubes extends to respective openings provided in the heater layer. The open surface area of the heater layer 64 in a first region 67a is greater than the open surface area of the heater layer 64 in a second region 67b.

While the above described embodiments have in some respects focussed on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A heater assembly for an aerosol provision system, the heater assembly comprising:
a substrate;
a heater layer configured to generate heat when supplied with energy, the heater layer provided on a first surface of the substrate; and
a plurality of capillary tubes extending from another surface of the substrate through the heater layer provided at the first surface of the substrate,
wherein each of the capillary tubes extends to respective openings provided in the heater layer, and wherein the combined area of the openings per unit area of the heater layer in a first region of the heater layer is greater than the combined area of the openings per unit area of the heater layer in a second region of the heater layer.

2. The heater assembly of claim 1, wherein the first region is configured such that the rate of aerosol-generating material provided to the heater layer is greater than in the second region.

3. The heater assembly of claim 1, wherein the size of each of the openings of the capillary tubes in the first region is greater than the size of each of the openings in the second region.

4. The heater assembly of claim 1, wherein the heater assembly comprises a first group of capillary tubes each extending to openings of a first size and a second group of capillary tubes each extending to openings of a second size smaller than the first size, wherein the first region contains relatively more of the second group of capillary tubes than the second region.

5. The heater assembly of claim 4, wherein the first group of capillary tubes are uniformly distributed through the first and second regions.

6. The heater assembly of claim 4, wherein the second group of capillary tubes are provided only in the first region, and wherein the second group of capillary tubes are distributed around the openings of the first group of capillary tubes in the first region.

7. The heater assembly of claim 4, wherein in the first region, the number of capillary tubes in the second group of capillary tubes is greater than the number of capillary tubes in the first group of capillary tubes.

8. The heater assembly of claim 3, wherein the size of the openings is a parameter indicative of the area of the openings.

9. The heater assembly of claim 1, wherein the first region is a central region of the heater layer, and the second region is a region surrounding the first region.

10. The heater assembly of claim 1, wherein the density of the heater assembly in a first volume extending from the first region is less than the density of the heater assembly in a second volume extending from the second region.

11. The heater assembly of claim 1, wherein the first region and the second region each include at least one of the plurality of capillary tubes, wherein the capillary tube in the first region is not the capillary tube in the second region.

12. The heater assembly of claim 1, wherein the heater assembly further includes a third region, wherein the combined area of the openings per unit area of the heater layer in the second region of the heater layer is greater than the combined area of the openings per unit area of the heater layer in the third region of the heater layer.

13. The heater assembly of claim 12, wherein the third region comprises no capillary tubes.

14. An aerosol provision system comprising the heater assembly of claim 1.

15. The aerosol provision system of claim 14, wherein the aerosol provision system further comprises an air inlet configured to direct a flow of air towards the heater assembly such that, in use, a cooling effect of said air flow on the heater assembly is greater in the second region compared to a cooling effect of said flow of air on the heater assembly in the first region.

16. The aerosol provision system of claim 14, wherein the aerosol provision system further comprises an aerosol-generating material transport mechanism configured to, in use, supply aerosol-generating material at a first rate to the first region of the heater layer and to supply aerosol-generating material at a second rate to the second region of the heater layer, wherein the first rate is less than the second rate.

17. A method for manufacturing a heater assembly for an aerosol provision system, the method comprising:
providing a substrate;
providing a heater layer on a first surface of the substrate, the heater layer configured to generate heat when supplied with energy; and
providing a plurality of capillary tubes extending from another surface of the substrate through the heater layer provided at the first surface of the substrate,
wherein each of the capillary tubes extends to respective openings provided in the heater layer, and wherein the combined area of the openings per unit area of the heater layer in a first region of the heater layer is greater than the combined area of the openings per unit area of the heater layer in a second region of the heater layer.

18. A heater means for an aerosol provision system, the heater means comprising:
a substrate;
heater layer means configured to generate heat when supplied with energy, the heater layer means provided on a first surface of the substrate; and
a plurality of capillary means extending from another surface of the substrate through the heater layer means provided at the first surface of the substrate,
wherein each of the capillary means extends to respective openings provided in the heater layer means,
and wherein the combined area of the openings per unit area of the heater layer means in a first region of the heater layer means is greater than the combined area of the openings per unit area of the heater layer means in a second region of the heater layer means.
